(19) United States
(12) Patent Application Publication
(10) Pub. No.: US 2021/0365148 A1
(43) Pub. Date: Nov. 25, 2021

(54) TOUCH SUBSTRATE, DISPLAY DEVICE AND METHOD FOR ACQUIRING TOUCH COORDINATE

(71) Applicants: BEIJING BOE DISPLAY TECHNOLOGY CO., LTD., Beijing (CN); BOE TECHNOLOGY GROUP CO., LTD., Beijing (CN)

(72) Inventors: Jianting WANG, Beijing (CN); Rui GUO, Beijing (CN); Boxiao LAN, Beijing (CN); Song LIU, Beijing (CN)

(21) Appl. No.: 16/613,277

(22) PCT Filed: Mar. 12, 2019
(86) PCT No.: PCT/CN2019/077823

§ 371 Date: Nov. 13, 2019

(30) Foreign Application Priority Data
May 30, 2018 (CN) 201810539616.4

(51) Int. Cl. G06F 3/044; G06F 3/041

(52) U.S. Cl. CPC G06F 3/0445; G06F 3/0446; G06F 3/0412

(57) ABSTRACT

A touch substrate, a display device and a method for acquiring a touch coordinate are provided. The touch substrate includes: a base substrate, including a touch region and a leading wire region on a periphery of the touch region; a touch unit, which is in the touch region and includes a plurality of touch electrode groups; and a plurality of driver modules in the leading wire region. Each driver module is connected to at least one touch electrode group, and each touch electrode group is connected to only one driver module.

### CROSS-REFERENCE TO RELATED APPLICATION

The present application claims priority of Chinese Patent Application No. 201810539616.4 filed on May 30, 2018, the disclosure of which is incorporated herein by reference in its entirety as part of the present application.

### TECHNICAL FIELD

Embodiments of the present disclosure relate to a touch substrate, a display device and a method for acquiring a touch coordinate.

### BACKGROUND

With the development of display technology and touch sensing technology, current electronic devices, especially middle and small sized mobile terminals with human-computer interaction function, generally have display panels with touch function. The above-mentioned electronic device can realize the touch function by using a separate touch module, or can also realize the touch function by integrating the touch function into a touch structure in a display panel. At present, common touch sensing technologies include sensing technologies, such as capacitive touch, resistive touch, nano touch, electromagnetic touch, embedded infrared touch, and the like, to achieve the acquisition of a touch point, but the current touch driving method mostly adopts single board design.

Therefore, the current display substrate, display device and method for acquiring a touch coordinate still need to be improved.

### SUMMARY

In an aspect, the embodiments of the present disclosure provide a touch substrate. According to the embodiments of the present disclosure, the touch substrate includes: a base substrate, including a touch region and a leading wire region on a periphery of the touch region; a touch unit, which is in the touch region and includes a plurality of touch electrode groups; and a plurality of driver modules, which are in the leading wire region. Each driver module is connected to at least one of the plurality of touch electrode groups, and each touch electrode group is connected to only one of the plurality of driver modules. By dividing a screen into subregions, by dividing a plurality of touch electrodes into the touch electrode groups and by connecting the plurality of touch electrodes to the plurality of driver modules, the touch substrate can avoid complex leading wires caused by connecting the plurality of touch electrodes in the touch unit to a same drive IC, improve the sensitivity signal-to-noise ratio, increase the touch reaction speed, simplify the assembly process, and greatly reduce the design cost and processing cost.

According to at least one embodiment of the present disclosure, the plurality of touch electrode groups include a plurality of driving electrode groups and a plurality of sensing electrode groups, each driving electrode group includes a plurality of driving electrodes, and each sensing electrode group includes a plurality of sensing electrodes; and the plurality of driver modules include a plurality of transmission driver modules and a plurality of sensing driver modules, each transmission driver module is connected to at least one of the plurality of driving electrode groups, and each sensing driver module is connected to at least one of the plurality of sensing electrode groups.

According to at least one embodiment of the present disclosure, the plurality of transmission driver modules are connected to the plurality of driving electrode groups in one-to-one correspondence; and the plurality of sensing driver modules are connected to the plurality of sensing electrode groups in one-to-one correspondence. Therefore, each driving electrode group and each sensing electrode group can be individually driven and controlled.

According to at least one embodiment of the present disclosure, the plurality of transmission driver modules are arranged along a first direction, the plurality of driving electrode groups are arranged along the first direction, the plurality of sensing driver modules are arranged along a second direction, and the plurality of sensing electrode groups are arranged along the second direction. Therefore, the space occupied by the plurality of driver modules in the leading wire region can be saved, and it is beneficial to narrow the frame and further simplify connection lines between the plurality of touch electrodes and the plurality of driver modules.

According to at least one embodiment of the present disclosure, adjacent ones of the plurality of driver modules are connected by a connection line. According to the embodiments of the present disclosure, the connection line includes at least one selected from the group consisting of a power line, a grounded shield line, a synchronization control signal line and a coordinate adjustment signal line. Therefore, data transmission and interaction among the plurality of driver modules can be simply realized, and the performance of the plurality of driver modules is further improved.

According to at least one embodiment of the present disclosure, at least one of the plurality of driver modules is connected to a signal output terminal, and the signal output terminal is configured to output a signal of USB type, SPI type, I2C type or QSPI type. Therefore, data output can be easily realized.

According to at least one embodiment of the present disclosure, the touch substrate includes a plurality of signal output terminals, the plurality of signal output terminals are connected to the plurality of driver modules in one-to-one correspondence, and the plurality of signal output terminals are on sides of the plurality of driver modules away from the touch region. Therefore, data output can be easily realized.

According to at least one embodiment of the present disclosure, each driver module includes a memory, a processor, and a computer program that is stored by the memory and executed by the processor, and the computer program implements at least one selected from the group consisting of threshold adjustment, reference voltage correction, wave filtering and noise elimination during execution of the computer program by the processor. Therefore, the performance of the driver module can be further improved.

According to at least one embodiment of the present disclosure, the touch substrate is a display substrate and the touch region is a display region.

According to at least one embodiment of the present disclosure, at least two touch electrode groups among the plurality of touch electrode groups are in a same layer.

In another aspect, the embodiments of the present disclosure provide a display device. According to the embodiments of the present disclosure, the display device includes the touch substrate described above. Therefore, the display device has all the features and advantages of the touch substrate described above, and repeated descriptions are omitted herein.

In yet another aspect, the embodiments of the present disclosure provide a method for acquiring a touch coordinate in the touch substrate or the display device as described above. According to the embodiments of the present disclosure, the method includes: dividing the touch region into a plurality of subregions; driving the plurality of touch electrode groups in different ones of the plurality of subregions in the touch region to scan by using the plurality of driver modules; obtaining the subregion where a touch point is located among the plurality of subregions and a subregion coordinate of the touch point in the subregion where the touch point is located, according to sensing data obtained in different subregions; and obtaining a touch coordinate of the touch point in the touch region by performing coordinate conversion on the subregion coordinate of the touch point in the subregion where the touch point is located. Therefore, the touch coordinate can be simply and accurately obtained.

According to at least one embodiment of the present disclosure, the plurality of touch electrode groups include a plurality of driving electrode groups and a plurality of sensing electrode groups, each driving electrode group includes a plurality of driving electrodes, and each sensing electrode group includes a plurality of sensing electrodes; the plurality of driver modules include a plurality of transmission driver modules and a plurality of sensing driver modules, each transmission driver module is connected to at least one of the plurality of driving electrode groups, and each sensing driver module is connected to at least one of the plurality of sensing electrode groups.

According to at least one embodiment of the present disclosure, the plurality of driving electrode groups in different ones of the plurality of subregions in the touch region are driven to transmit excitation signals by the plurality of transmission driver modules connected to the plurality of driving electrode groups; and the plurality of sensing electrode groups in different ones of the plurality of subregions in the touch region are driven to synchronously scan by the plurality of sensing driver modules connected to the plurality of sensing electrode groups. Therefore, scanning time can be saved and processing speed can be improved.

According to at least one embodiment of the present disclosure, the dividing the touch region into the plurality of subregions includes: dividing the touch region of the touch substrate into the plurality of subregions according to a number of the plurality of transmission driver modules and a number of the plurality of sensing driver modules, wherein a number of the plurality of subregions obtained by dividing the touch region is a product of the number of the plurality of transmission driver modules and the number of the plurality of sensing driver modules.

According to at least one embodiment of the present disclosure, before the dividing the touch region of the touch substrate into the plurality of subregions, the method further includes: determining the number of the plurality of transmission driver modules, according to a total number of the driving electrodes included in the touch region of the touch substrate and a number of transmission channels included in each transmission driver module; and determining the number of the plurality of sensing driver modules, according to a total number of the sensing electrodes included in the touch region and a number of receiving channels included in each sensing driver module.

According to at least one embodiment of the present disclosure, the obtaining the touch coordinate of the touch point in the touch region by performing the coordinate conversion on the subregion coordinate of the touch point in the subregion where the touch point is located includes: according to a width of touch electrodes in the plurality of touch electrode groups in the touch region, a spacing between adjacent ones of the touch electrodes, a number of the plurality of subregions and a number of channels included in each driver module, obtaining the touch coordinate of the touch point in the touch region by performing the coordinate conversion on the subregion coordinate of the touch point in the subregion where the touch point is located.

According to at least one embodiment of the present disclosure, before the performing coordinate conversion on the subregion coordinate of the touch point in the subregion where the touch point is located, the method further includes: performing swap with adjacent subregion according to the subregion coordinate of the touch point adjacent to a subregion boundary; determining a touch characteristic function and selecting a multi-point processing algorithm, according to a touch sensing characteristic of the touch substrate; according to the touch characteristic function and by the multi-point processing algorithm, performing multi-point operation processing on the subregion coordinate, after the swap with the adjacent subregion, of the touch point to obtain an operation result; and re-determining the subregion coordinate of the touch point adjacent to the subregion boundary according to the operation result. Therefore, the accuracy of obtaining the coordinate can be improved.

### BRIEF DESCRIPTION OF THE DRAWINGS

In order to clearly illustrate the technical solutions of the embodiments of the present disclosure, the drawings of the embodiments will be briefly described in the following; it is obvious that the described drawings are only related to some embodiments of the present disclosure and thus are not limitative to the present disclosure.

FIG. 1 shows a partial structural schematic view of a display substrate;

FIG. 2 shows a structural schematic view of a touch electrode group according to at least one embodiment of the present disclosure;

FIG. 3 shows a structural schematic view of a touch substrate according to at least one embodiment of the present disclosure;

FIG. 4A shows a structural schematic view of the touch substrate according to at least one embodiment of the present disclosure;

FIG. 4B shows a structural schematic view illustrating that a driving electrode group and a sensing electrode group as shown in FIG. 4A are respectively connected to corresponding driver modules;

FIG. 5 shows a partial structural schematic view of the touch substrate according to at least one embodiment of the present disclosure;

FIG. 6 shows a partial structural view of the touch substrate according to yet another embodiment of the present disclosure;

FIG. 7 shows a partial structural schematic view of the touch substrate according to yet another embodiment of the present disclosure; and

FIG. 8 shows a flow chart of a method for acquiring a coordinate of a touch point according to at least one embodiment of the present disclosure.

### DETAILED DESCRIPTION

In order to make objects, technical details and advantages of the embodiments of the present disclosure apparent, the technical solutions of the embodiments will be described in a clearly and fully understandable way in connection with the drawings related to the embodiments of the present disclosure. Apparently, the described embodiments are just a part but not all of the embodiments of the present disclosure. Based on the described embodiments herein, those skilled in the art can obtain other embodiment(s), without any inventive work, which should be within the scope of the present disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “comprise,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may comprise an electrical connection, directly or indirectly. “On,” “under,” and the like are only used to indicate relative position relationship, and when the absolute position of the object which is described is changed, the relative position relationship may be changed accordingly.

The embodiments of the present disclosure are based on the inventors' discovery and understanding of the fact that the current touch driving mode mostly adopts a single board design. In the above-mentioned touch single board design, all touch electrodes on a same substrate are respectively connected to a same driver module (or called driving circuit board, for example, a driving IC (integrated circuit)) through a plurality of leading wires, and the driver module sends a signal to the outside through another leading wire, which causes defects such as long leading wires, low signal-to-noise ratio, complex leading wires, complex processes, difficult processing, etc. In addition, all touch electrodes on the same substrate are connected to the same driver module, resulting in a complex structure and high cost of the driver module itself. Especially in a case where the design of embedded touch screen (in which a touch module is integrated into a display panel) is adopted, the process of integrating the driver module with the display panel is complex and difficult to process. Moreover, the complex leading wires structure not only affects the signal-to-noise ratio of electrical signals, but also easily causes a binding region of the display panel (such as an array substrate of the display panel) to become warped and the like defects.

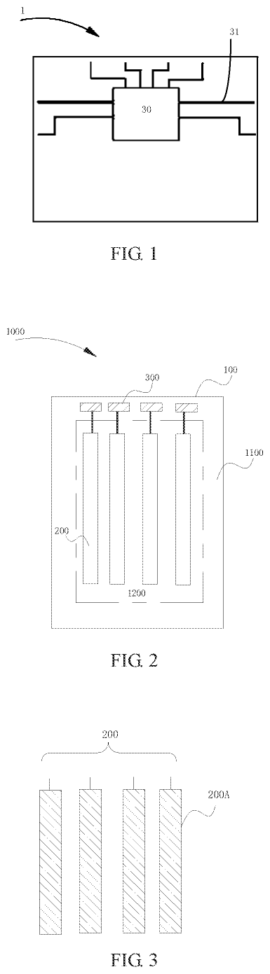

Referring to FIG. 1, for example, only one driver module 30 is provided in the current display panel, and each of a plurality of touch electrodes (not shown) in the display substrate 1 is connected to the driver module 30 through the leading wire 31 (only eight leading wires are schematically shown in FIG. 1) to realize signal transmission or sensing. Even middle and small sized display devices are usually equipped with hundreds of touch electrodes in order to meet the requirements of touch point detection accuracy, which results in a complex leading-wire connection structure, and the circuit structure of the driver module 30 itself is complex. However, if the leading wires are too long, it is easily affected by environmental noise and random noise. Although measures such as software noise reduction or shielding can be adopted, software noise reduction greatly reduces the touch response speed. The measures of shielding or leading wire avoidance not only increase the cost of the product, but also often easily lead to poor contact and complex process of the binding region due to a large number of transmitting and receiving pins and stress factors because of pulling. There are still potential safety hazards caused by warping in regions subjected to a high pressure, and there is no good fundamental solution to reporting points caused by structural extrusion. Moreover, the driver module 30 is not only connected to the plurality of touch electrodes, but also connected to an external circuit (such as an external control IC) for data transmission and interaction.

In an aspect of the present disclosure, the embodiments of the present disclosure provide a touch substrate. For example, a display substrate with a touch function (including a touch unit) is provided; that is, the touch substrate is, for example, the display substrate. The touch unit includes a plurality of touch electrodes to realize the detection of a touch point.

According to the embodiments of the present disclosure, referring to FIG. 2, the touch substrate 1000 includes a base substrate 100, and the base substrate includes a touch region 1200 (an inner region of a dashed frame) and a leading wire region 1100 around the touch region. The touch unit included in the touch substrate is in the touch region, and the touch unit includes a plurality of touch electrode groups 200 to realize sensing of a touch point. The leading wire region 1100 is provided with a plurality of driver modules 300 (for example, each driver module 300 is a drive circuit board, for example, a drive IC), each driver module 300 is connected to at least one touch electrode group 200, and each touch electrode group 200 is connected to only one driver module 300. In other words, each driver module 300 may be connected to one or more touch electrode groups 200, and there is no driver module 300 that is not connected to the touch electrode group 200. Each touch electrode group 200 is connected to only one driver module 300, that is, each touch electrode group 200 is driven by only one driver module 300, and the one driver module 300 drives, for example, a plurality of groups of touch electrode groups 200. By dividing a plurality of touch electrodes into the groups and connecting the plurality of touch electrodes to the plurality of driver modules (the plurality of driver modules apply a same touch signal to the plurality of touch electrodes), the touch substrate can avoid complex leading wires caused by connecting the plurality of touch electrodes in the touch unit to the same driver module, improve the sensitivity signal-to-noise ratio, increase the touch reaction speed, simplify the assembly process, and greatly reduce the design cost and processing cost.

For example, at least two touch electrode groups among the plurality of touch electrode groups included in the touch substrate 1000 are in a same layer, i.e., the touch electrodes of the at least two touch electrode groups are in a same layer (i.e., the touch electrodes of the at least two touch electrode groups are formed by a same film).

For example, the touch substrate 1000 is the display substrate having a display function, and accordingly, the touch region 1200 is a display region for displaying a picture. In other embodiments, the touch substrate 1000 may be a substrate without the display function as long as it has the touch function.

The respective structures of the touch substrate will be described in detail below according to specific embodiments of the present disclosure.

According to the embodiments of the present disclosure, a specific structure of the touch unit, a touch sensing principle, the number and shape of the touch electrodes are not limited. For example, the touch unit is a capacitive touch unit, a resistive touch unit, a nano touch unit, an electromagnetic touch unit, an embedded infrared touch unit, or the like.

The capacitive touch unit may adopt projected capacitive touch and has advantages such as high precision, fast response speed and a large number of touch points. The capacitive touch unit is taken as an example, and the touch principle of the touch unit may be of self-capacitance type or mutual capacitance type. For example, in a case where the touch unit adopts the self-capacitance type of touch principle, the touch unit senses the touch point through the self-capacitance type of touch electrodes, and the touch unit includes the plurality of touch electrodes in a same layer, and the touch point is determined by detecting a change value of a capacitance formed between adjacent touch electrodes. In order to improve the sensitivity of self-capacitance detection, a reference electrode that is grounded or applied with a fixed reference value may be additionally arranged as a reference, and the touch point may be determined by detecting the change of the capacitance between adjacent touch electrodes and changes of capacitances respectively formed between two adjacent touch electrodes and the reference electrode. For example, in a case where the touch unit adopts the mutual capacitance type of touch principle, the touch unit includes a plurality of driving electrodes and a plurality of sensing electrodes, and a high-frequency voltage is applied to the driving electrodes to form capacitances between the driving electrodes and the sensing electrodes. At this time, in a case where a conductor (such as a user's finger or a touch pen, etc.) performs touch operation on the touch substrate, capacitances between the driving electrodes at the touch point and the plurality of sensing electrodes are changed, thereby realizing detection of the touch point. The plurality of driving electrodes and the plurality of sensing electrodes may be or may not be formed in a same layer; for example, the plurality of driving electrodes are formed in a structure of a same layer, the plurality of sensing electrodes stacks the layer where the driving electrodes are arranged, and the plurality of sensing electrodes are spaced apart from the layer where the driving electrodes are arranged by an insulating substance between the plurality of sensing electrodes and the layer where the driving electrodes are arranged. The specific shape of the touch electrodes (including the plurality of self-capacitance type of touch electrodes, or including the plurality of mutual capacitance type of driving electrodes and the plurality of sensing electrodes) is not particularly limited. For example, the touch electrodes are strip electrodes, planar electrodes or hollow electrodes. The plurality of touch electrodes in the same layer may be arranged in parallel or in a structure of interdigital electrodes (such as a single-layer self-capacitance type of touch unit). The sensing electrodes may be perpendicular to the driving electrodes, or projections of the sensing electrodes and projections of the driving electrode in a direction perpendicular to the base substrate may be not overlapped with each other. Those skilled in the art can set the above parameters of the touch unit according to the actual situation.

According to at least one embodiment of the present disclosure, referring to FIG. 3, each touch electrode group 200 may include the plurality of touch electrodes 200A. For example, the plurality of touch electrodes 200A are in a same layer, that is, the plurality of touch electrodes 200A are formed by a same film. The plurality of touch electrodes 200A in the same touch electrode group 200 are connected to the same driver module and the driver module performs unified control on the plurality of touch electrodes 200A in the touch electrode group 200. Then, the touch point can be obtained by performing unified processing on data of the plurality of driver modules. Therefore, the plurality of touch electrode groups 200 can be used to realize subregion touch processing on a screen: each driver module is responsible for sensing the touch points only at positions of the touch electrodes that each driver module is connected to. Because each touch electrode group 200 is connected to a corresponding driver module, the touch point condition for the entire touch substrate can be obtained by performing the unified processing on the data of the plurality of driver modules. In the touch substrate according to the embodiments of the present disclosure, the number of touch electrodes, that each driver module is responsible for driving, is small, so compared with the case where the entire touch substrate has only one touch IC, the touch substrate according to the embodiments of the present disclosure does not need the complex leading wire structure. In addition, after the subregion touch processing is performed, because an amount of data required to be processed by each driver module is greatly reduced, the circuit structure of the driver module itself can be correspondingly simplified. Therefore, the production cost can also be reduced and the assembly process can be simplified.

According to the embodiments of the present disclosure, the specific manner in which the driver modules drive the touch electrode groups is not particularly limited, and can be designed by those skilled in the art according to the specific conditions of the touch unit. The connection relationships between the driver modules and the touch electrode groups are not particularly limited. For example, the driver modules and the touch electrode groups are connected in one-to-one correspondence, in this case, each driver module is connected to one touch electrode group, and each touch electrode group is also connected to only one driver module. Alternatively, for example, several touch electrode groups may be connected to one driver module. The mutual capacitance type of touch unit is taken as an example, the touch unit may include a plurality of driving electrode groups and a plurality of sensing electrode groups, all the driving electrode groups included in the touch unit may be connected to one driver module, and the sensing electrode groups and the remaining driver modules may be connected in one-to-one correspondence, which means that each sensing electrode group is connected to only one driver module; and other than the one driver module connected to the driving electrode groups, each of the remaining driver modules is also connected to only one sensing electrode group. Similarly, for example, the plurality of sensing electrode groups are connected to a same driver module, and the driving electrode groups and the remaining driver modules are connected in one-to-one correspondence.

In the following, the specific conditions of the driver modules and the touch electrode groups will be described in detail only by taking a double-layer mutual capacitance type of touch unit as an example.

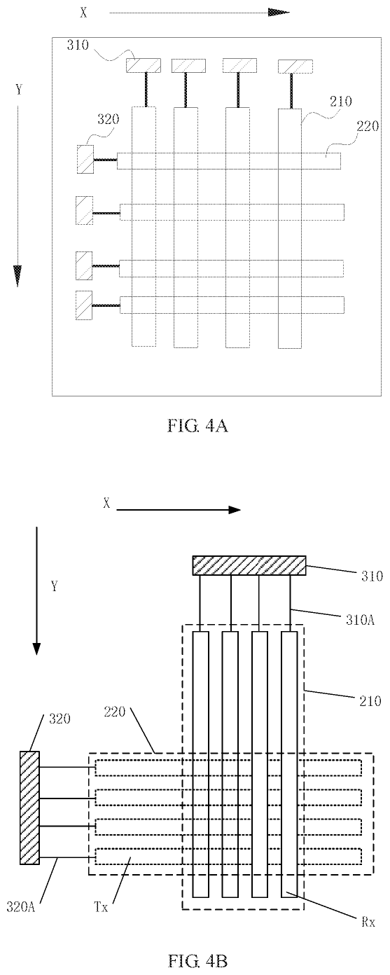

According to some embodiments of the present disclosure, referring to FIG. 4A, the touch electrode groups may include the plurality of driving electrode groups 220 and the plurality of sensing electrode groups 210. Each driving electrode group 220 includes a plurality of driving electrodes (Tx, as shown in FIG. 4B, the number of Tx includes but is not limited to the embodiment as shown in FIG. 4B), and each sensing electrode group 210 includes sensing electrodes (Rx, as shown in FIG. 4B, the number of Rx includes but is not limited to the embodiment as shown in FIG. 4B). The plurality of driver modules in the touch substrate include a plurality of transmission driver modules 320 and a plurality of sensing driver modules 310. The transmission driver modules 320 are connected to the driving electrode groups 220 respectively so as to drive the driving electrode groups 220 to realize signal transmission; and the sensing driver modules 310 are connected to the sensing electrode groups 210 respectively so as to drive the sensing electrode groups 210 to scan touch signals. For example, the transmission driver modules 320 are connected to the driving electrode groups 220 in one-to-one correspondence. For example, the sensing driver modules 310 are connected to the sensing electrode groups 310 in one-to-one correspondence. Thus, each driving electrode group and each sensing electrode group can be individually driven and controlled.

According to at least one embodiment of the present disclosure, the plurality of driving electrode groups 220 may be arranged in a first direction (Y direction as shown in the figures) and the plurality of sensing electrode groups 210 may be arranged in a second direction (X direction as shown in the figures). For example, the plurality of driving electrodes Tx included in each driving electrode group 220 are sequentially arranged in the first direction and extend in the second direction, and the plurality of sensing electrodes Rx included in each sensing electrode group 210 are sequentially arranged in the second direction and extend in the first direction. One of the first direction and the second direction may be a row direction and the other of the first direction and the second direction is a column direction; that is, the plurality of driving electrode groups 220 may be arranged in a plurality of rows, and at this time, the plurality of sensing electrode groups 210 may be arranged in a plurality of columns.

In order to facilitate the transmission driver modules 320 and the sensing driver modules 310 to be connected to corresponding electrode groups (the sensing electrode groups 210 and the driving electrode groups 220) nearby, the plurality of transmission driver modules 320 may also be arranged in sequence along the first direction. Therefore, connection lines 320A connecting the driving electrode groups 220 and the transmission driver modules 320 only need to extend slightly toward the leading wire region, that is, the driving electrode groups 220 can be connected to the transmission driver modules 320 arranged in the first direction without causing the connection lines in the leading wire region to be too long. Similarly, the plurality of sensing driver modules 310 may be sequentially arranged along the second direction. Therefore, it is convenient to connect the sensing driver modules 310 and the sensing electrode groups 210 also arranged along the second direction through connection lines 310A. For example, the transmission driver modules 320 are arranged in the column direction, and the sensing driver modules 310 are arranged in the row direction, instead of being arranged at a certain place in the leading wire region, so that neither the sensing electrode groups 210 nor the driving electrode groups 220 need to be provided with complex connection lines to be connected to the corresponding driver modules. In addition, the leading wire region of the touch substrate (e.g., the display substrate) is usually arranged at a periphery of the touch region, for example, the leading wire region may be a region surrounding the touch region. Therefore, in order to facilitate the connection and data exchange between the plurality of transmission driver modules 320 and the plurality of sensing driver modules 310, the above two groups of driver modules may be respectively arranged at two adjacent edges in the leading wire region. Therefore, even if the plurality of transmission driver modules 320 and the plurality of sensing driver modules 310 are subsequently connected through the connection lines, the connection lines extends along distribution directions of the driver modules to realize the connection of all the driver modules. Therefore, the space occupied by the driver modules and the connection lines in the leading wire region can be saved, the frame can be narrowed, the connection lines between the touch electrode groups and the driver modules can be further simplified, and the sensing electrode groups 210, the sensing driver modules 310, the driving electrode groups 220 and the transmission driver modules 320 can be connected nearby.

It should be noted that the driving electrode groups 220 and the sensing electrode groups 210 may be arranged in different layers. As shown in FIGS. 4A and 4B, the driving electrode groups 220 may be disposed below the sensing electrode groups 210 (the driving electrode groups 220 are shown in broken lines), and two layers of electrode groups are separated by an insulating layer. The transmission driver modules 320 and the sensing driver modules 310 are arranged in the leading wire region and can be connected to the touch electrodes in corresponding touch electrode groups through via holes.

According to at least one embodiment of the present disclosure, referring to FIG. 5, adjacent driver modules 300 may be connected by the connection line 10. The connection line 10 may include at least one selected from the group consisting of a power line, a grounded shield line, a synchronization control signal line and a coordinate adjustment signal line. Therefore, data transmission and interaction among the plurality of driver modules can be simply realized, and the performance of the driver modules is further improved. For example, the driver module 300 drives the touch electrodes to emit a signal or drives the touch electrodes to scan line by line, to realize the detection of the touch point. Because the touch substrate according to the embodiments of the present disclosure is provided with the plurality of driver modules, the data of the plurality of driver modules 300 needs to be integrated to obtain a coordinate of the touch point on the entire touch substrate. Therefore, the above-mentioned connection line 10 may include the power line for supplying a voltage to the driver modules 300, the grounded shield line for preventing interference between the driver modules 300 or interference caused by other circuit structures in the leading wire region to the driver modules 300, the synchronization control signal line related to timing control, or the coordinate adjustment signal line connected to a calculator unit, or the like. The specific number, type, and other external circuit structures or terminals of the connection line 10 can be designed by those skilled in the art according to the actual situation.

According to at least one embodiment of the present disclosure, for example, one of the plurality of driver modules 300 is further connected to a signal output terminal 400 for signal outputting. The signal output terminal 400 may be configured to output a signal of USB (universal serial bus) type, SPI (serial peripheral interface) type, I2C (inter-integrated circuit) type, or QSPI (queued SPI) type. Thus, data output can be easily realized. According to at least one embodiment of the present disclosure, in a case where the plurality of driver modules 300 are distributed on two adjacent edges of the leading wire region, the signal output terminal 400 may be at one terminal of the outermost driver module 300 (300A or 300B as shown in the figure). That is, the signal output terminal 400 may be on a side, that is not adjacent to other driver module 300, of the outermost driver module 300. Thus, the circuit structure of the leading wire region can be further simplified.

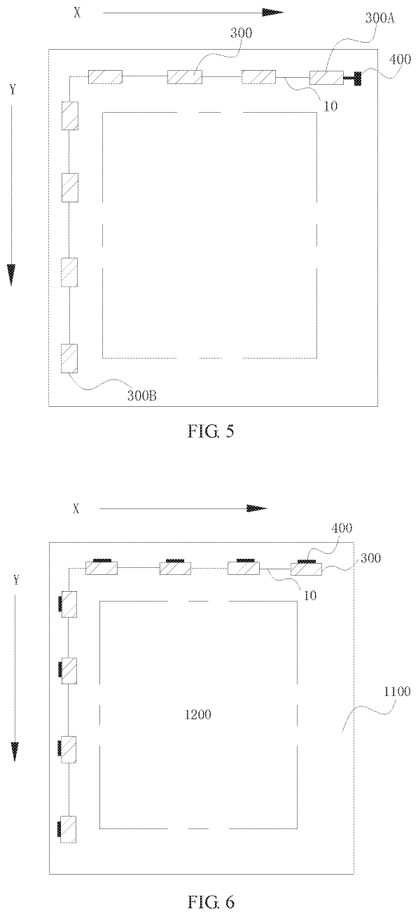

According to at least one embodiment of the present disclosure, the touch substrate may further include a plurality of signal output terminals 400. For example, referring to FIG. 6, the signal output terminals 400 are connected to the driver modules in one-to-one correspondence. The signal output terminals 400 are on the sides of the driver modules 300 away from the touch region. Thus, data output can be easily realized.

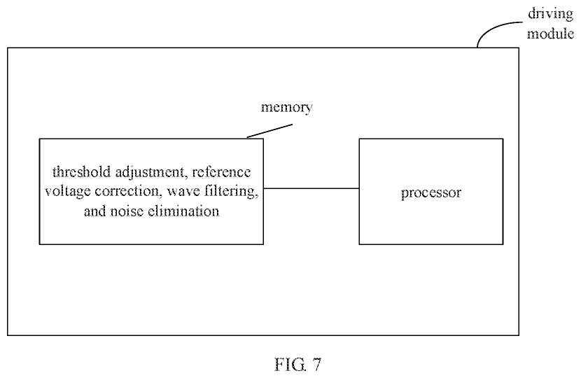

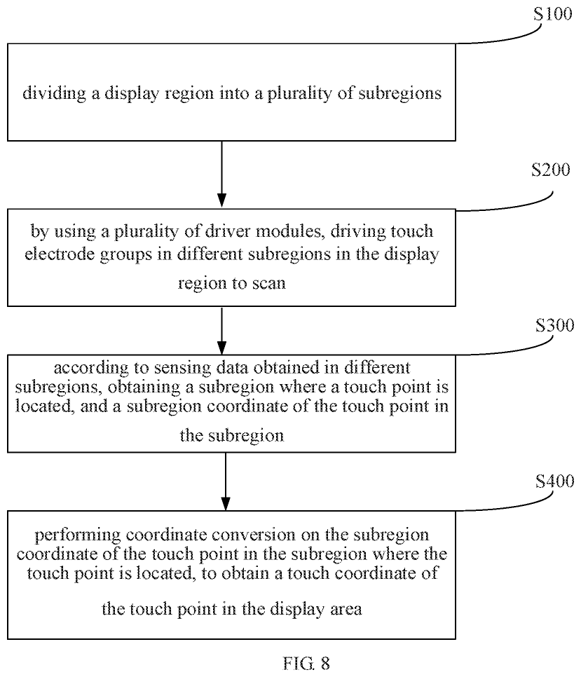

According to at least one embodiment of the present disclosure, each driver module 300 may further include a memory, a processor, and a computer program which is stored by the memory and is executable by the processor. For example, referring to FIG. 7, the computer program is configured to implement at least one of functions selected from the group consisting of threshold adjustment, reference voltage correction, wave filtering, noise elimination, and the like, in a case where the processor executes the computer program. Therefore, the performance of the driver module can be further improved: each driver module 300 is equivalent to an independently separated single channel, and each channel can perform software control adjustment on threshold, reference, frequency, etc. That is, each driver module 300 can individually perform the above adjustment on its touch signal. Therefore, on the one hand, the touch coordinate information obtained by each driver module 300 can be ensured to have higher accuracy, and on the other hand, because the number of touch electrodes that each driver module 300 is connected to is small, the calculation speed of touch sensing can also be increased.

In general, the touch substrate according to the embodiments of the present disclosure has at least one of the following advantages.

(1) The plurality of touch electrodes are divided into groups to realize dividing the screen into subregions, and the driver module is connected with the touch electrodes near the driver module, thus simplifying the leading wire structure, shortening lengths of the leading wires and improving the sensitivity signal-to-noise ratio.

(2) The number of the touch electrodes that each driver module is connected to is reduced, and the structure of the driver module itself is simplified.

(3) The processing speed is increased by adjusting the coordinate algorithm (each driver module can process the signal separately and the amount of information processed by each driver module is reduced).

(4) The assembly process is greatly simplified and the design cost and processing cost are greatly reduced through a design of using a strip-shaped PCB for the subregion (the design of connecting the touch electrode group in the subregion to the driver module realized through the strip-shaped PCB; for example, the driver module in FIG. 4B is a strip-shaped flexible printed circuit board (PCB)).

In another aspect of the present disclosure, the embodiments of the present disclosure provide a display device. According to the embodiments of the present disclosure, the display device includes the touch substrate described above. Therefore, the display device has all the features and advantages of the touch substrate described above, and repeated descriptions are omitted herein.

In another aspect of the present disclosure, the embodiments of the present disclosure provide a method for acquiring touch coordinates in the touch substrate or the display device as described above. According to at least one embodiment of the present disclosure, referring to FIG. 8, the method may include the following steps S100, S200, S300, and S400.

S100: dividing the touch region (for example, the display region) into a plurality of subregions.

According to at least one embodiment of the present disclosure, in this step S100, the touch region is firstly divided. For example, the touch region is divided into the plurality of subregions according to the number of the driver modules. By taking the touch unit including the plurality of driving electrode groups and the plurality of sensing electrode groups as an example, the touch region of the touch substrate may be divided into the plurality of subregions according to the number of the transmission driver modules and the number of the sensing driver modules. The number of the subregions obtained by dividing the touch region is a product of the number of the transmission driver modules and the number of the sensing driver modules. Therefore, the number of the driver modules can be saved while the touch accuracy is ensured. Otherwise, if each subregion is provided with one driver module, the number of the subregions of the touch substrate is reduced in the situation where the number of the driver modules is not increased. The number of the touch electrode groups of the touch substrate is certain, and the reduction of the number of the subregions results in an increase in the number of the touch electrode groups included in a single subregion, and an increase in the number of the touch electrodes that each driver module is connected to, thus complicating the structure of the connection lines and the driver modules themselves; if the number of the touch electrodes that the driver module is connected to is reduced in order to ensure the number of the subregions of the touch substrate, more driver modules are introduced, thus causing a substantial increase in production costs.

For example, before determining the subregions, the number of the transmission driver modules is determined according to a total number of the driving electrodes included in the touch region in the touch substrate and the number of transmission channels included by each transmission driver module; and the number of the sensing driver modules is determined according to a total number of the sensing electrodes included in the touch region and the number of receiving channels included by the sensing driver module.

For example, the number of the transmission driver modules and the number of the sensing driver modules can be determined by the following methods.

Generally, after the driver module is produced, a total number of the receiving channels or transmission channels that the driver module has is fixed. A plurality of channels of the driver module may be not all connected to the touch electrodes, but a maximum value of the touch electrodes that each driver module can be connected to is determined by the number of the channels. In order to simplify the assembly process and save the production cost, for example, a plurality of identical drive IC are used as the plurality of transmission driver modules according to the embodiments of the present disclosure. The total number of the driving electrodes (i.e., the total number of the transmission channels) of the plurality of driving electrode groups is TX, the total number of the sensing electrodes (i.e., the total number of the receiving channels) of the plurality of sensing electrode groups is RX, the number of the transmission channels of each transmission driver module is TX′, the number of the receiving channels of each sensing driver module is RX′, then the number X of the transmission driver modules distributed along the first direction may be:

X=int(T_{X}/T_{X}′)+1;

The number Y of the sensing driver modules distributed along the second direction may be:

Y=int(R_{X}/R_{X}′)+1.

Int(k) is a function of rounding down a value k to an integer i nearest to the value k, so that the integer i nearest to the value k is smaller than the value k. Because the above determination process adopts a method of rounding and then adding one, the total number of selected channels of the plurality of driver modules is greater than a total number of the touch electrodes included in the actual touch region. In this case, the number of channels used by the plurality of driver modules is defined: according to a specific embodiment of the present disclosure, the plurality of sensing electrode groups include 128 sensing electrodes in total, i.e., Rx is 128 in the above formula, and each selected sensing driver module includes 35 receiving channels, i.e., each sensing driver module can be connected to up to 35 sensing electrodes, and RX′ in the above formula is 35. Then the number Y of the sensing driver modules calculated according to the above formula is: after 128 is divided by 35, a quotient is rounded and added with one. It should be noted that “rounded” here is not round-up, but all values after a decimal point in the quotient are discarded. If the quotient of 128 divided by 35 is 3.657, then 3 is obtained after the rounding and is added with one to obtain the value Y of 4, i.e. 4 sensing driver modules are used. The maximum number of the sensing electrodes that the 4 sensing driver modules can be actually connected to is 140, and the number of the sensing electrodes that can be connected is 128, so 12 channels are unused without connecting with the sensing electrodes and without receiving or transmitting data. Therefore, it is necessary to define that how many channels in each driver module are unused before performing subsequent processing steps. The specific conditions of channels that are unused may not be particularly limited. The unused channels may be evenly distributed among the plurality of driver modules, or all the channels that need to be unused may be distributed in one driver module or among a few driver modules.

According to at least one embodiment of the present disclosure, by using the above process to determine the number of the transmission driver modules and the number of the sensing driver modules, it is not necessary to allow the total number of connectable channels in the driver modules to be strictly equal to the total number of the touch electrodes. Therefore, regardless of the total number of channels that can be connected in the selected driver modules or the total number of the touch electrodes included in the touch substrate, the number of the driver modules that need to be adopted can be calculated and obtained simply by using the above formula. In addition, in a case where the number of the driver modules is determined by the above steps, the plurality of driver modules that are identical can be adopted, which needs a subsequent step that the number of the touch electrodes that each driver module is actually connected to is determined by simple definition, without the need of designing the driver modules with different numbers of channels, so that the number of the receiving channels in the driver modules comprehensively satisfies the requirement of the total number of the touch electrodes, and the cost is convenient to save.

S200: driving the touch electrode groups in different subregions in the touch region to scan by using the plurality of driver modules.

According to at least one embodiment of the present disclosure, in this step S200, the plurality of driver modules are used to drive the touch electrode groups in different subregions to scan. For example, scanning in the plurality of subregions can be performed simultaneously or sequentially. The touch electrodes included in the touch electrode groups in the same subregion scan sequentially.

The touch electrode groups including the driving electrode groups and the sensing electrode groups are taken as an example, for example, the scanning process may include: driving the driving electrode groups in different subregions in the touch region to emit excitation signals by the transmission driver modules connected to the driving electrode groups; and driving the sensing electrode groups in different subregions in the touch region to scan by the sensing driver modules connected to the sensing electrode groups. For example, the sensing electrode groups in different subregions can perform synchronous scanning Therefore, scanning time can be saved and processing speed can be improved.

According to the embodiments of the present disclosure, in this step S200, the specific manner in which the transmission driver modules controls the driving electrode groups to emit the excitation signals is not particularly limited. For example, the transmission driver modules according to at least one embodiment of the present disclosure may apply, for example, an excitation signal with a high frequency (e.g., a square wave or a sine wave that may have a frequency of several hundred kHz) to the driving electrode groups. Due to the principle of electromagnetic induction, the sensing electrodes generate sensing charges, and an electric field is formed between the driving electrodes and the sensing electrodes, thereby forming capacitances between the driving electrodes and the sensing electrodes. In a case where a touch conductor (such as a user's finger or a touch pen) performs touch operation, the touch conductor affects the electric field and further affects the capacitances formed between the driving electrodes and the sensing electrodes. The sensing driver modules drive the sensing electrode groups to scan to obtain the capacitances of each sensing electrode in the sensing electrode groups, and the touch point is obtained through subsequent processing.

S300: obtaining the subregion where the touch point is located and the coordinate (also referred as a subregion coordinate) of the touch point in the subregion where the touch point is located, according to sensing data obtained in different subregions.

According to at least one embodiment of the present disclosure, for example, the sensing data (e.g., sensing data of Rx) which is obtained is processed to determine the subregion coordinate of the touch point in each subregion. The above-mentioned processing may include: by comparing sensing data obtained by the sensing electrodes in a same subregion, determining whether the touch point is in this subregion, and determining the position of the touch point in this subregion (i.e., the subregion coordinate of the touch point in the subregion where the touch point is located). The above process can be implemented by the driver module that each subregion corresponds to. According to at least one embodiment of the present disclosure, the driver module that each subregion corresponds to can perform software control adjustment on threshold, reference, frequency and the like, which thus is beneficial to improving the accuracy of acquired coordinate data.

According to at least one embodiment of the present disclosure, in order to improve the accuracy of touch sensing, in a case of a detection that the touch point is located at a position adjacent to a subregion boundary (e.g., the touch point is located in a region where 2 to 3 rows of touch electrodes adjacent to the subregion boundary are located), the step S300 may further include steps S310 to S340 related to re-determining the subregion coordinate of the touch point in the subregion.

S310: performing swap with adjacent subregion, according to the subregion coordinate of the touch point adjacent to the subregion boundary. For example, in step S310, it is determined that the touch point is located at a first touch electrode in a first subregion and is adjacent to a subregion boundary between the first subregion and a second subregion adjacent to the first subregion according to the subregion coordinate of the touch point, and then data of a second touch electrode that is located in the second subregion and is adjacent to the first touch electrode is transmitted to the driver module to which the first touch electrode is connected, the process is referred to as the swap with adjacent subregion. Therefore, swap can be performed on the data of several rows of touch electrodes located at the boundary of the two subregions, and the driver module connected to the touch electrodes, where the touch point is located, simultaneously processes the data of the several rows of touch electrodes located in the two subregions in subsequent steps, so that the coordinate of the touch point can be more accurately determined.

S320: for example, after the swap of data of the several rows of touch electrodes adjacent to the subregion boundary, determining a touch characteristic function, according to a touch sensing characteristic of the touch substrate, and selecting a multi-point processing algorithm.

S330: according to the touch characteristic function, performing multi-point operation processing on the subregion coordinate of the touch point after the swap with adjacent subregion by using the multi-point processing algorithm to obtain an operation result.

S340: according to the operation result, re-determining the subregion coordinate of the touch point adjacent to the subregion boundary. Therefore, the accuracy of the obtained coordinate can be improved.

In other embodiments, for example, in the situation where it is determined that the subregion coordinate of the touch point is adjacent to the position of the subregion boundary, a position coordinate of the touch point is firstly determined based on the touch characteristic function of inner touch electrodes in a present subregion (i.e., the first subregion where the touch point is located); subsequently, the swap is performed by using data of several rows of touch electrodes in an adjacent subregion (the second subregion adjacent to the first subregion), and position coordinates, which are determined according to a plurality of rows of touch electrodes after the swap (which belong to the two adjacent subregions, namely the first subregion and the second subregion) based on respective touch characteristic functions of the plurality of rows of the touch electrodes, are compared; and according to these determined position coordinates, a final coordinate of the touch point in the present subregion (i.e. the re-determined subregion coordinate) is determined.

According to the embodiments of the present disclosure, the “touch sensing characteristic” refers to a relationship between a capacitance value of a sensing capacitance detected by the touch electrode and a distance between the touch point and the touch electrode. The touch characteristic function is a functional relationship between the capacitance value of the sensing capacitance and the distance. In a case where the touch operation occurs, it not only affects the touch electrode at the touch point, but also has certain influence on capacitance values of nearby electrodes. Different distances between the touch point and the touch electrodes have different effects on the sensing capacitance. Based on the touch characteristic function of the touch electrode, the distance between the touch point and the touch electrode can be determined, thus the above-mentioned position of the touch point is determined. There is usually certain gaps between the plurality of touch electrodes. In a case where the touch point is not located at the position of the touch electrode but in the gap, the sensing capacitance, which is detected, also changes, and the change value of the sensing capacitance is related to the distance between the touch point and the touch electrode.

The “multi-point operation processing” includes: inquiring the touch characteristic function of several adjacent rows of touch electrodes (such as adjacent two or three rows); and based on the position of the touch point obtained according to the touch characteristic function of the several adjacent touch electrodes, determining the coordinate of the touch point through a plurality of inquiries and comparisons. The touch position obtained according to the multi-point processing algorithm is more accurate than the touch position obtained by inquiring one touch electrode.

The above multi-point processing algorithm is not limited to the case where the touch point is adjacent to the subregion boundary. In fact, the determination of the coordinate of the touch point each time can be realized through the multi-point processing algorithm.

In a case where the touch point occurs at a central position of the subregion, the multi-point operation processing is realized, for example, by the driver module of the subregion.

In a case where the touch point is adjacent to the subregion boundary (e.g. 2 to 3 rows of touch electrodes located at an outermost edge position of the subregion), data of the several rows of touch electrodes in the next subregion adjacent to the subregion is inquired for reference to realize the multi-point operation processing. Because touch electrodes on a periphery of the touch point are located in other subregion, if the swap with adjacent subregion is not performed, the number of touch electrodes that can be referenced during the multi-point processing algorithm is reduced, resulting in the reduction the sensing accuracy of the touch position in the case where the touch point is adjacent to the edge of the subregion. Therefore, in a case where it is determined that the touch point is located around the several rows of touch electrodes adjacent to the subregion boundary, the above subregion swap processing can be performed to perform the swap with the sensing data of the several rows of touch electrodes in the adjacent subregion, and the accuracy of touch sensing at the subregion boundary can be improved.

S400: obtaining a touch coordinate of the touch point in the touch region by performing coordinate conversion on the subregion coordinate of the touch point in the subregion where the touch point is located.

According to the embodiments of the present disclosure, in this step S400, the coordinate of the touch point obtained by processing each subregion needs to be converted to obtain the coordinate of the touch point in the touch region: as mentioned above, because the touch region is divided into the plurality of subregions according to the method of the embodiments of the present disclosure, the coordinate calculated in each subregion needs to be converted into the coordinate position in the entire touch region. According to at least one embodiment of the present disclosure, the above step S400 may be implemented by the following mode: according to a width of the touch electrodes in the touch electrode groups in the touch region, a spacing between adjacent touch electrodes, the number of the subregions and the number of the channels included in each driver module, performing coordinate conversion on the coordinate of the touch point in the subregion where the touch point is located to obtain the touch coordinate of the touch point in the touch region. Therefore, the touch coordinate can be simply and accurately obtained.

For example, in step S400, the area that the present subregion actually occupies in the touch region is determined according to the width of the touch electrodes, the distance between adjacent touch electrodes and the total number of the touch electrodes (i.e., the number of channels included in the driver modules) included in the present subregion, i.e., the length and width of the present subregion are determined. Then, the touch coordinate, which is obtained, is converted according to the present subregion where the touch point is located and according to the area of the subregion adjacent to the present subregion: for example, referring to FIG. 4A, the subregion coordinate of the touch point detected in the subregion located in a second column along the X direction and in a first row along the Y direction are (1,1), then the position of the touch coordinate of the touch point in the entire touch region along the X direction is obtained based on adjustment according to a length along the X direction of the subregion located in the first column along the X direction and in the first row along the Y direction, and the coordinate value along the X direction of the subregion coordinate needs to be added with the length along the X direction of its adjacent subregion to obtain a real coordinate position of the touch point in the touch region.

To sum up, the method adopts a mode of dividing the screen into subregions, different subregions can scan synchronously, driver modules of the plurality of subregions are cascaded, and sensitive signals are processed at the edge of the screen through the coordinate adjustment algorithm, so that the sensitivity signal-to-noise ratio is improved, and the speed is increased.

Those skilled in the art can combine and assemble different embodiments or examples described in this specification and features of different embodiments or examples without contradicting each other.

What are described above is related to the illustrative embodiments of the disclosure only and not limitative to the scope of the disclosure; the scopes of the disclosure are defined by the accompanying claims.

1. A touch substrate, comprising:
a base substrate, comprising a touch region and a leading wire region on a periphery of the touch region;
a touch unit, which is in the touch region and comprises a plurality of touch electrode groups; and
a plurality of driver modules, wherein the plurality of driver modules are in the leading wire region, each driver module is connected to at least one of the plurality of touch electrode groups, and each touch electrode group is connected to only one of the plurality of driver modules.

2. The touch substrate according to claim 1, wherein
the plurality of touch electrode groups comprise a plurality of driving electrode groups and a plurality of sensing electrode groups, each driving electrode group comprises a plurality of driving electrodes, and each sensing electrode group comprises a plurality of sensing electrodes; and
the plurality of driver modules comprise a plurality of transmission driver modules and a plurality of sensing driver modules, each transmission driver module is connected to at least one of the plurality of driving electrode groups, and each sensing driver module is connected to at least one of the plurality of sensing electrode groups.

3. The touch substrate according to claim 2, wherein
the plurality of transmission driver modules are connected to the plurality of driving electrode groups in one-to-one correspondence; and
the plurality of sensing driver modules are connected to the plurality of sensing electrode groups in one-to-one correspondence.

4. The touch substrate according to claim 3, wherein the plurality of transmission driver modules are arranged along a first direction, the plurality of driving electrode groups are arranged along the first direction, the plurality of sensing driver modules are arranged along a second direction different from the first direction, and the plurality of sensing electrode groups are arranged along the second direction.

5. The touch substrate according to claim 1, wherein adjacent ones of the plurality of driver modules are connected by a connection line.

6. The touch substrate according to claim 5, wherein the connection line comprises at least one selected from the group consisting of a power line, a grounded shield line, a synchronization control signal line and a coordinate adjustment signal line.

7. The touch substrate according to claim 5, wherein at least one of the plurality of driver modules is connected to a signal output terminal, and the signal output terminal is configured to output a signal of USB type, SPI type, I2C type or QSPI type.

8. The touch substrate according to claim 7, further comprising:
a plurality of signal output terminals, wherein the plurality of signal output terminals are connected to the plurality of driver modules in one-to-one correspondence, and the plurality of signal output terminals are on sides of the plurality of driver modules away from the touch region.

9. The touch substrate according to claim 1, wherein each driver module comprises a memory, a processor, and a computer program that is stored by the memory and executed by the processor, and the computer program implements at least one selected from the group consisting of threshold adjustment, reference voltage correction, wave filtering and noise elimination during execution of the computer program by the processor.

10. The touch substrate according to claim 1, wherein the touch substrate is a display substrate and the touch region is a display region.

11. The touch substrate according to claim 1, wherein at least two touch electrode groups among the plurality of touch electrode groups are in a same layer.

12. A display device, comprising the touch substrate according to claim 1.

13. A method for acquiring a touch coordinate in a touch substrate wherein
the touch substrate comprises: a base substrate, comprising a touch region and a leading wire region on a periphery of the touch region; a touch unit, which is in the touch region and comprises a plurality of touch electrode groups; and a plurality of driver modules, wherein the plurality of driver modules are in the leading wire region, each driver module is connected to at least one of the plurality of touch electrode groups, and each touch electrode group is connected to only one of the plurality of driver modules; and
the method comprises:
dividing the touch region into a plurality of subregions;
driving the plurality of touch electrode groups in different ones of the plurality of subregions in the touch region to scan by using the plurality of driver modules;
obtaining the subregion where a touch point is located among the plurality of subregions and a subregion coordinate of the touch point in the subregion where the touch point is located, according to sensing data obtained in different subregions; and
obtaining a touch coordinate of the touch point in the touch region by performing coordinate conversion on the subregion coordinate of the touch point in the subregion where the touch point is located.

14. The method according to claim 13, wherein
the plurality of touch electrode groups comprise a plurality of driving electrode groups and a plurality of sensing electrode groups, each driving electrode group comprises a plurality of driving electrodes, and each sensing electrode group comprises a plurality of sensing electrodes;
the plurality of driver modules comprise a plurality of transmission driver modules and a plurality of sensing driver modules, each transmission driver module is connected to at least one of the plurality of driving electrode groups, and each sensing driver module is connected to at least one of the plurality of sensing electrode groups.

15. The method according to claim 14, wherein
the plurality of driving electrode groups in different ones of the plurality of subregions in the touch region are driven to transmit excitation signals by the plurality of transmission driver modules connected to the plurality of driving electrode groups; and
the plurality of sensing electrode groups in different ones of the plurality of subregions in the touch region are driven to synchronously scan by the plurality of sensing driver modules connected to the plurality of sensing electrode groups.

16. The method according to claim 14, wherein the dividing the touch region into the plurality of subregions comprises:
dividing the touch region of the touch substrate into the plurality of subregions according to a number of the plurality of transmission driver modules and a number of the plurality of sensing driver modules, wherein a number of the plurality of subregions obtained by dividing the touch region is a product of the number of the plurality of transmission driver modules and the number of the plurality of sensing driver modules.

17. The method according to claim 16, wherein before the dividing the touch region of the touch substrate into the plurality of subregions, the method further comprises:
determining the number of the plurality of transmission driver modules, according to a total number of the driving electrodes comprised in the touch region of the touch substrate and a number of transmission channels comprised in each transmission driver module; and
determining the number of the plurality of sensing driver modules, according to a total number of the sensing electrodes comprised in the touch region and a number of receiving channels comprised in each sensing driver module.

18. The method according to claim 13, wherein the obtaining the touch coordinate of the touch point in the touch region by performing the coordinate conversion on the subregion coordinate of the touch point in the subregion where the touch point is located comprises:
according to a width of touch electrodes in the plurality of touch electrode groups in the touch region, a spacing between adjacent ones of the touch electrodes, a number of the plurality of subregions and a number of channels comprised in each driver module, obtaining the touch coordinate of the touch point in the touch region by performing the coordinate conversion on the subregion coordinate of the touch point in the subregion where the touch point is located.

19. The method according to claim 13, wherein before the performing coordinate conversion on the subregion coordinate of the touch point in the subregion where the touch point is located, the method further comprises:
in presence of a detection that the touch point is adjacent to a subregion boundary between a first subregion and a second subregion among the plurality of subregions, performing swap with adjacent subregion according to the subregion coordinate of the touch point adjacent to the subregion boundary, wherein the swap with adjacent subregion comprises: transmitting data of a touch electrode, which is located in the second subregion adjacent to the first subregion and is adjacent to another touch electrode where the touch point is located in the first subregion, to the driver module to which the another touch electrode is connected;
determining a touch characteristic function and selecting a multi-point processing algorithm, according to a touch sensing characteristic of the touch substrate;
according to the touch characteristic function and by the multi-point processing algorithm, performing multi-point operation processing on the subregion coordinate, after the swap with the adjacent subregion, of the touch point to obtain an operation result; and
re-determining the subregion coordinate of the touch point adjacent to the subregion boundary according to the operation result.
